(19) United States
(12) Patent Application Publication
(10) Pub. No.: US 2013/0275520 A1
(43) Pub. Date: Oct. 17, 2013

(54) Bragging Rights Social Media Business Integrator

(71) Applicant: Alexander Gibson Biehn, Decatur, GA (US)

(72) Inventor: Alexander Gibson Biehn, Decatur, GA (US)

(73) Assignee: Alexander Gibson Biehn, Decatur, GA (US)

(21) Appl. No.: 13/447,223

(22) Filed: Apr. 15, 2012

(51) Int. Cl. G06F 15/16

(52) U.S. Cl. 709/206

(57) ABSTRACT

Software linking corporate social media to Enterprise Business email and documents, capturing popularity and allowing sharing between environments.

### OVERVIEW

Computer readable software, processes and methods for providing a link between corporate social media packages and Enterprise Business email and document creation software (e.g. Microsoft Outlook, Word, Excel and PowerPoint) in order to capture the readership popularity and usefulness of user published emails, documents, charts and graphs and the sharing of these emails, documents and charts and graphs on corporate Social Media sites belonging to the creator of the documents and other community members who elect to ‘favorite,’ comment upon or ‘share’ these publications. Over time, the amount of ‘favorite-ed,’ comment upon' and ‘shared’ material published per user is tallied and analyzed for usefulness and relevance for the group and each user is ranked and rated for their contributions to the corporation based on their publishing prowess and popularity in the group.

### SUMMARY AND BACKGROUND

The SMI takes aspects of popular corporate social media systems used by Enterprise Businesses and integrates them with popular Enterprise publishing and email communications suites (e.g. Microsoft Exchange and Office Suite). The SMI enables corporate employees to share and rate each other's work across their corporate community along with voting and polling on various ideas and decisions. Additionally, it includes analytics that enable supervisors or system administrators to see how employees work is rated and shared by others in the organization.

1. Background

First, “ Web 2.0” (Wiki's, blogs, social media sites) has seen a huge proliferation in the past years. Many new private social media systems for large businesses have subsequently been deployed using many of the same features used in the public systems. Yet businesses have not found a way to link more conventional communication and publishing systems (email and document creation) that are still heavily used in the business environment to the new corporate social media environment. Examples include email messages, Microsoft Office Suite (Word Documents, Powerpoint presentations and Excel spreadsheets). Corporate documents are generally shared by creating central folders that are cumbersome to search and rate for relevance. Finding information can be difficult in the Enterprise business world.

Second, Corporate Social Media software (e.g. Clearvale, Ideaplane, IBM Lotus Connections to name a few) has tried to mimic the success of Social Media in people's personal lives by creating business efficiencies on the sites. These products have missed their potential of disseminating information and aiding productivity because they are cordoned off from the most important corporate information which is tied up in corporate publication servers such as the ones mentioned in the above paragraph.

Third, there has been a rise of Social Media influence measurement systems that are used in private Social Media. Yet in conventional Enterprise business performance ratings are still largely a manual process that consists of an employee presenting her portfolio annually to her supervisor and having her supervisor make a determination based on portfolio. Preparing the portfolio is time consuming and the effort level differs by employee and makes fair evaluations difficult.

The Analytics gathered by the SMI measures the number of unique documents created and shared by an employee and whether the document is shared by other employees. Additionally, it measures how many peers vote to like a document or comment on its usefulness. This raw data provides a fair and accurate depiction of an employee's ‘influence’ in the Enterprise. While new and different than the way ‘influence’ is measured in public social media , the SMI mimics these rating systems for Enterprises for the purpose of annual performance review.

2. Summary

The SMI process, methods and computer readable software integrates publication and communication systems with Corporate Social Media. One aspect imbeds an electronic tool bar on emails and documents that allows others to ‘Favorite’ these publications on their corporate social media site. Additionally, it allows authors and the author's community to “Share” these documents from the social media sites so other community members read and share them with their community. Email authors may also use an email integrated polling feature that allows an email author to create a poll in the body of the email that recipients can vote upon. Results of the vote are tallied and presented on the author's social media site avoiding the normal crush of emails associated with a polling question that is traditionally sent out by email soliciting an audience response.

SMI then links to Enterprise Social Media software products (e.g. Clearvale, Ideaplane, IBM Lotus Connections to name a few). Finally, analytics show system administrators the number of documents published or shared by a user and the number of “Favorites and ‘Shares” a user garners from their original work.

The Analytics gathered by the SMI measures the number of unique documents created and shared by an employee and whether the document is shared by other employees. Additionally, it measures how many peers vote to like a document or comment on its usefulness. This raw data provides a fair and accurate depiction of an employee's ‘influence’ in the Enterprise. While new and different than the way ‘influence’ is measured in public social media, the SMI mimics these rating systems for Enterprises for the purpose of annual performance review.

Detailed Description of the Social Media Integrator (SMI):

The below functions of the SMI invention are meant to outline all the possible uses of the SMI, but is not meant to infer that each function cannot be used independently of the others or in conjunction with just some of the other functions.

The first function of the SMI is to present hyperlinked ‘Favorite’ on Enterprise email communications. When a user ‘Favorites’ an email two things happen. First, the vote is compiled in Analytics and the author is notified via their Corporate Social Media notification process. Second, notification of the ‘Favorite’ is posted to the Corporate Social Media page of both the author and person ‘Favorite-ing’ it. There is an option to allow the person approving of the email to write a brief reason why which will also post to the author and reviewer social media pages. The original email can be either made public via the Social Media site or only the Subject line or subject line shown. Comments can be made either public or private, viewable to just the author or the author and her Social Media Community.

Another function of the SMI presents a hyperlinked ‘Share’ button on Enterprise publication software documents, charts and presentation. Additionally, the ‘Share’ button can be extended to web 2.0 functions such as original short audio/video media, blogs, etc. The author may chose to ‘Share’ their work from the document creation screen. The SMI receives this signal and writes a copy of the document to the Social Media page of the author. The document is electronically water marked to denote the author and is accessible to everyone in the author's Social Media community. The hyperlinked ‘Share’ button can remain on the document so it can be further shared by others who download from the Social Media page of the author or anyone in the Social Media group who downloads it if desired.

A third function of the SMI is to allow simple polling via email with an imbedded link for each choice presented. Each recipient can click on the choice they prefer and the results are tallied by the SMI and posted automatically on the social media site of the author.

A final function of the SMI is to tally and analyze the importance and popularity of individual author's work that is shared/favorite-ed in the two functions above. The SMI will compile the number of documents an author ‘Shared’ in the Social Media environment. The SMI will also count how many times others download those documents or mark them as a ‘Favorite’. Emails that are ‘Favorite-ed’ by others are also compiled at the author level. System administrators and company supervisors may view these analytics for the purposes of review and rating an employee's work and relevance to the greater corporate environment.

The attached drawings outline the physical and logical flow of information in order to perform the functions of the invention described in the previous paragraphs and in the abstract, summary and claims.

### BRIEF DESCRIPTION OF DRAWINGS

With regards to FIG. 1 the Toolbar for “Favorite” and “Share” (1.a) is shown as it relates to documents (1.b) that are ideas of various Authors (1.c) in the corporate environment. The Authors share a common document-creation and email system and a common corporate Social Media System (1.d). Documents that are ‘Favorite-ed” or “Shared” are logged in the SMI (1.e). The SMI (1.e) then presents the documents stored in the corporate email/publication software (e.g. Microsoft Office Suite) as hyperlinked icons in the appropriate Social Media pages belonging to the author and reviewer. Any comments typed in the toolbar by reviewers are also logged and presented in the Social Media System. 106 Shows that the analytics taken from the SMI system can be used for feedback and review with the Authors to establish their importance and relevance to the corporation by objective measurement.

Concerning FIG. 2, the diagram shows how a corporate email is processed and integrated into the Corporate Social Media environment by the SMI. Bob (c) at ABC Co. has written an original email (a) that he sends to Sally (d) and a few others at ABC Co. (e). When Sally clicks the toolbar to ‘Favorite’ the email, the SMI (f) communicates with both the Corporate Email Server (j) and the Corporate Social Media Server (i) to present a digest of the email (b) on both Sally's and Bob's Social Media page (g and h). The SMI notifies the author and review of the posting.

Concerning FIG. 3, the diagram shows how a document written on ABC Co's corporate document publication server(s) (h) is integrated into the Corporate Social Media environment (g) by the SMI (d). In this example Bob (c) has created an original document or piece of media (a). He decides to click the toolbar on the document by the SMI (d) to “Share” his document. The SMI (d) communicates with both the document server (h) and Social Media server (g) to present a hyperlink and digest of the document (b) on Bob's Social Media site for his community to view. Bob can refer other community members by postings on his social media page, email, or otherwise that the document he created is available for sharing from his social media page. In this case Sally is in Bob's community and decides to use Bob's document. She can simply download it for use by clicking on the icon on Bob's social media page. Sally has also opted to “Share” Bob's work (b) on her social media page (e) for her community members. Sally has also written a review of the work and has ‘Favorite-ed’ it. The SMI tallies the sharing and reviews and alerts parties of proliferation while compiling analytics. Once again, analytics are used for objective review of authors in the company and the relevance and popularity of their individual work.

FIG. 4 shows various aspects of the polling function. In this example corporate email user Bob (c) sends and email (a) to corporate recipients (i) from his corporate email server (e). Via a tool bar in his email that the SMI embeds Bob click ‘Polling’. The SMI (d) prompts him on the number of choices and a corresponding number of hyperlinked blue boxes appear in the body of the email being sent (b). Recipients click on one of the boxes to vote (b) and a message is sent to the SMI (d). The SMI (d) tallies the votes (h) and posts them Bob's social media site (f) for review.

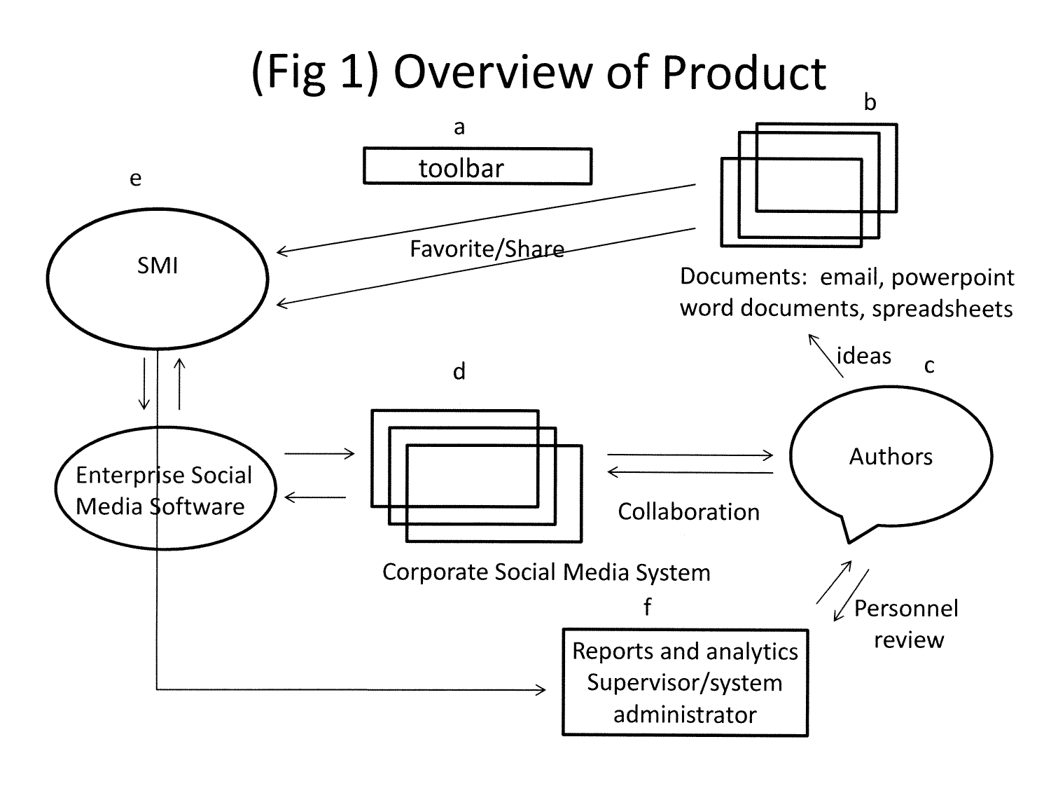

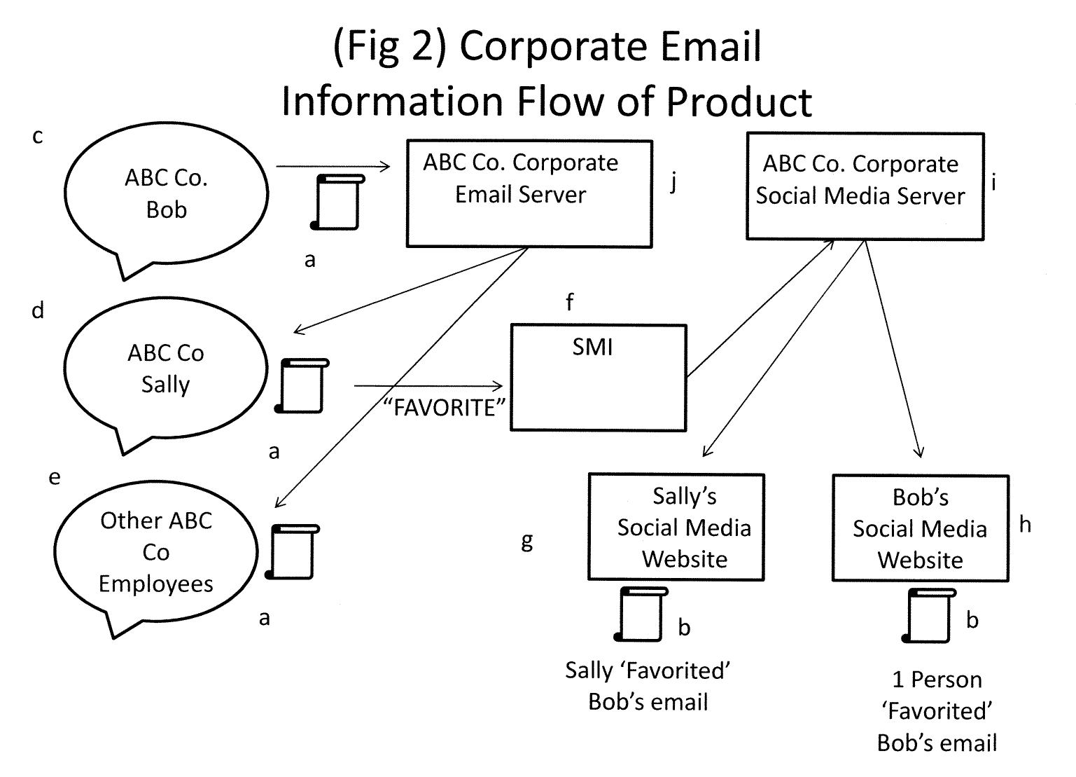

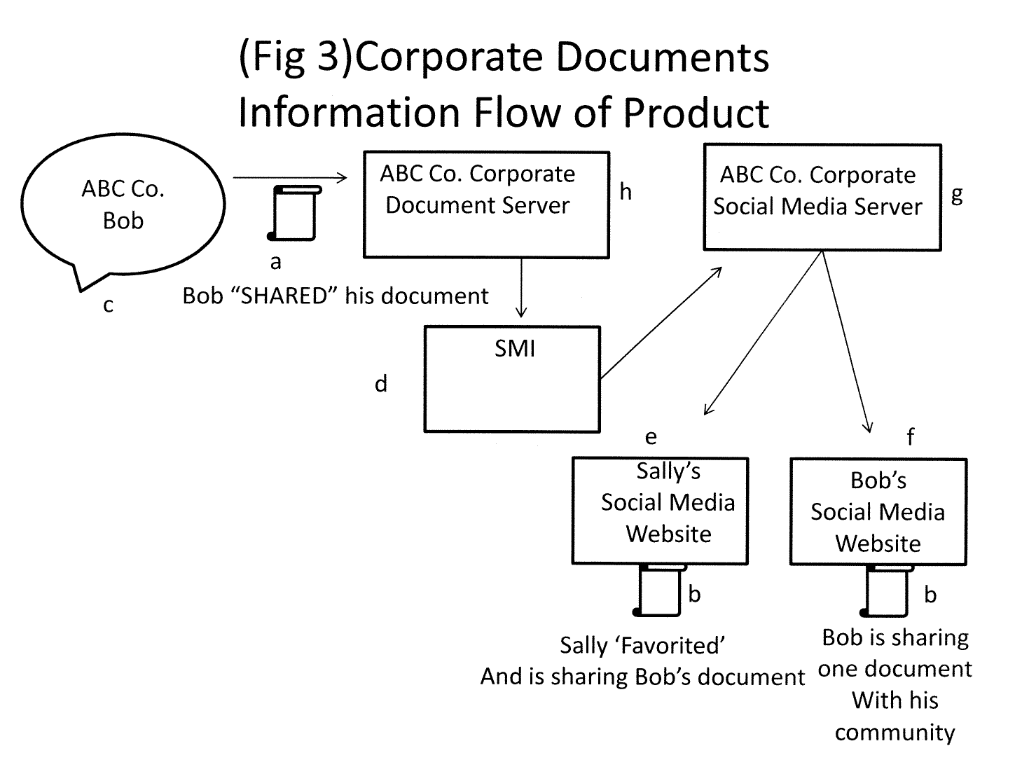

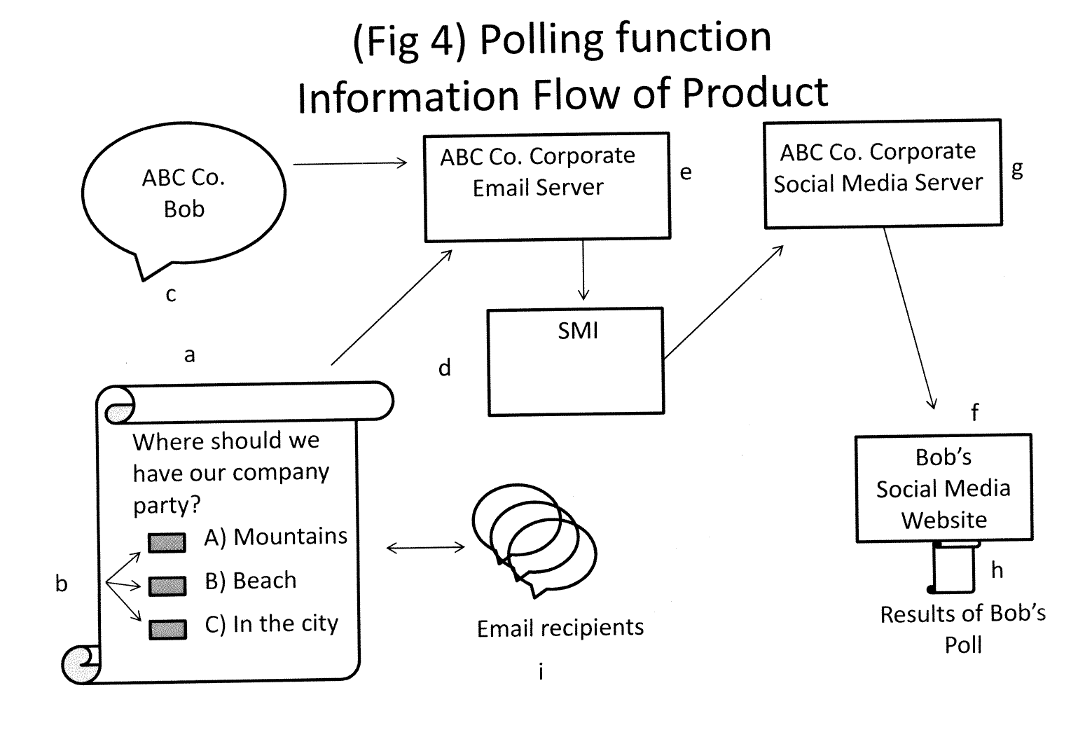

### BRIEF DESCRIPTION OF EXAMPLES PROVIDED

Example 1 shows in a general sense how the “Favorite” toolbar (a) would reside on a corporate email. By clicking on this toolbar the SMI would message author and reviewer and control the deposition of the email in the corporate social media environment. The SMI controls the toolbar.

Example 2 similarly shows the ‘Favorite’ toolbar on a corporate document/media (a). By clicking on this toolbar the SMI would message author and reviewer and control the deposition of the document/media in the corporate social media environment. The ‘Share’ toolbar (b) allows the author (or viewer, if desired) of the document/media to post a link to a copy of the document/media on their corporate Social Media page. Community members go to the author's corporate Social Media site to view or download copies of the document and ‘Favorite’, ‘Share’ or briefly comment upon them. The SMI controls the toolbar.

Example 3 shows a basic outline of the Analytics offered by the SMI. User information is either manually loaded or collected from the Social Media server. The SMI will tally the number of documents/media and type of media ‘shared’ by each user. Reviews including ‘Favorites’, comments and re-sharing (or the sharing of a shared document on another Social Media page are tallied and consolidate by user. Weighted importance of proliferation and peer interest are customizable by corporate client or group of users. The decided upon metrics will rank and rate users in a specific group or across the organization. The analytics can be used by senior management to determine relative corporate productivity over a given period or can be used to objectively measure individuals for annual reviews and merit increases to salary, bonus or promotion in the company.

The invention claimed is:

1. Computer readable software that integrates corporate email onto corporate social media sites by means of a presenting an executable toolbar that the software embeds in the email. Readers of the email can ‘Favorite’ or comment upon an email and the invention will then transfer details of the transaction to the corporate social media site of the author and recipient of the email.

2. Concerning claim 1, The methods and processes by which the above integration is logged, analyzed and presented by the software to determine to determine the relevance and importance of individual employee/authors tied to the corporate email and social media servers being integrated.

3. Computer readable software that presents documents and media created on corporate servers by employee/authors onto that author's corporate social media site in the following way: An author may share a document to their social media site by clicking a presented toolbar that the software embeds in the each document as it is being created. The invention moves the document or a hyperlink to the document to the author's social media site. Authors may write a summary concerning the document from the presented toolbar in the document. This summary is then presented on the authors social media site. Community Members of the Author's social media site can download the document directly from the Social Media site by means of the invention's software.

4. Claim 3 further comprising of the toolbar being presented to community members who download the shared document. This toolbar on the documents allows the readers of the document to ‘Favorite’ it, comment upon it, or ‘Share’ it on their social media site by clicking a presented toolbar in the downloaded document. Documentation of the favorite/comment/share is then posted on the reader and author's social media site by the software.

5. Further concerning claim 4, the methods and processes by which the above integration is logged, analyzed and presented by the software to determine the relevance and importance of individual employee/authors tied to the corporate email and social media servers being integrated.

6. Computer readable software that integrates corporate email onto corporate social media sites by means of a toolbar that the software embeds in the email in order to: conduct polling. Author chooses ‘Polling’ and is prompted on the number of choices. Blue hyperlink boxes are embedded in the email and the author types the choice corresponding to each next to them. Readers may vote by clicking on the box corresponding to their choice and the invention will tally the results in real time and update the social media site of the author with the results.
